(19) United States
(12) Patent Application Publication
(10) Pub. No.: US 2002/0129289 A1
(43) Pub. Date: Sep. 12, 2002

(54) Personal computer

(76) Inventor: Shigenobu Sato, Iruma-shi (JP)

Correspondence Address: Finnegan, Henderson, Farabow,, Garrett & Dunner, L.L.P., 1300 I Street, N.W., Washington, DC, 20005-3315, US

(21) Appl. No.: 09/949,793

(22) Filed: Sep. 12, 2001

(30) Foreign Application Priority Data
Sep. 25, 2000 (JP) 2000-291174

(51) Int. Cl. G06F 1/26; G06F 1/28; G06F 1/30; G06F 11/30

(52) U.S. Cl. 713/340

(57) ABSTRACT

An infrared controller is connected to a CPU of a PC main body via an ECKBC. A programmable ROM, light-emitting unit, operation light-receiving unit, and learning light-receiving unit are connected to a controller unit of the infrared controller. The light-emitting unit is used to transmit an infrared signal for remote-controlling an external electronic device. The operation light-receiving unit is used to receive an infrared signal for remote-controlling the internal circuit of the PC main body, which is emitted by an external remote controller. The learning light-receiving unit is used to learn the emission pattern of an infrared signal for remote-controlling an unregistered external electronic device.

### CROSS-REFERENCE TO RELATED APPLICATIONS

This application is based upon and claims the benefit of priority from the prior Japanese Patent Application No. 2000-291174, filed Sep. 25, 2000, the entire contents of which are incorporated herein by reference.

### BACKGROUND OF THE INVENTION

1. Field of the Invention

The present invention relates to a personal computer (PC) and, more particularly, to a PC which can remote-control an external electronic device by an electromagnetic wave such as an optical signal or the like and/or a PC which can remote-control an internal circuit by an electromagnetic wave such as an optical signal or the like.

2. Description of the Related Art

In homes, many electronic devices that can be controlled by remote controllers, for example, a TV (Television), VTR (Videotape Recorder), air conditioner, illumination device, and the like are present. However, since dedicated remote controllers are prepared for those electronic device, many remote controllers are present in the home. Therefore, when the user wants to simultaneously control a plurality of devices using remote controllers, he or she must selectively use those remote controllers. For example, when the user wants to record a TV program, he or she must use two remote controllers to turn on the TV and to set the VTR. Also, when the user wants to dim out the room light upon watching a video program, he or she must use three remote controllers for the illumination device, VTR, and TV.

The following problems are also posed in association with remote controllers for electronic devices. That is, since remote controllers have no compatibility, the user must change a remote controller if he or she has changed a device main body, thus wasting the remote controller. Also, since the user must manually operate a remote controller near an electronic device, the electronic device cannot be controlled from outside the home.

On the other hand, PCs have prevailed in many home, and are used in various purposes and various user classes. However, the functions and operability of such PCs are still on the extension of conventional office computers, and are required to improve.

### BRIEF SUMMARY OF THE INVENTION

The present invention has been made in consideration of the conventional problems, and has as its object to broaden the use range of a PC to improve the remote controllability of electronic devices, and to prevent remote controllers from being wasted.

It is another object of the present invention to improve the operability of the PC itself.

According to a first aspect of the present invention, there is provided a PC comprising:

a main body which incorporates a computer circuit;

a light-emitting unit which externally emits light rays; and

an emission processor which is connected to the computer circuit and the light-emitting unit, and modulates the light rays emitted by the light-emitting unit to form an emission pattern of an optical signal for remote-controlling an external electronic device.

According to second first aspect of the present invention, there is provided a PC comprising:

a base unit which incorporates a computer circuit and includes a keyboard;

a display unit which is pivotally attached to the base unit via a hinge portion;

a light-emitting unit which is disposed on the base unit and externally emits light rays; and

an emission processor which is connected to the computer circuit and the light-emitting unit, and modulates the light rays emitted by the light-emitting unit to form an emission pattern of an optical signal for remote-controlling an external electronic device.

According to a third aspect of the present invention, there is provided a PC comprising:

a main body which incorporates a computer circuit;

a light-emitting unit which externally emits light rays;

an emission processor which is connected to the computer circuit and the light-emitting unit, and modulates the light rays emitted by the light-emitting unit to form an emission pattern of an optical signal for remote-controlling an external electronic device;

a first light-receiving unit which receives external light rays; and

a first light-receiving processor which is connected to the computer circuit and the first light-receiving unit, and inputs a command to the computer circuit on the basis of an optical signal for remote-controlling the computer circuit, which is received by the first light-receiving unit,

wherein the light-emitting unit, the emission processor, the first light-receiving unit, and the first light-receiving processor are arranged to allow two individuals of the PC to be connected to each other by optical communications.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a block diagram showing the circuit arrangement of a PC shown in FIGS. 3A and 3B:

FIG. 2 is a block diagram showing specific part of the circuit arrangement shown in FIG. 1;

FIGS. 3A and 3B are respectively a perspective view showing a PC according to an embodiment of the present invention, and a plan view showing its base unit;

FIG. 4 shows an example of the data structure of an infrared signal;

FIG. 5 is a diagram showing the relationship between a PC and external electronic devices according to another embodiment of the present invention;

FIG. 6 is a diagram showing the relationship between a PC and external electronic devices according to still another embodiment of the present invention;

FIG. 7 is a diagram showing the relationship between a PC and external electronic devices according to still another embodiment of the present invention;

FIG. 8 is a diagram showing the relationship between a PC and external electronic devices according to still another embodiment of the present invention; and

FIG. 9 is a diagram showing the relationship between two individuals of a PC according to still another embodiment of the present invention.

### DETAILED DESCRIPTION OF THE INVENTION

Embodiments of the present invention will be described hereinafter with reference to the accompanying drawings. In the following description, the constituent elements having substantially the same function and arrangement are denoted by the same reference numerals, and a repetitive description will be made only when necessary.

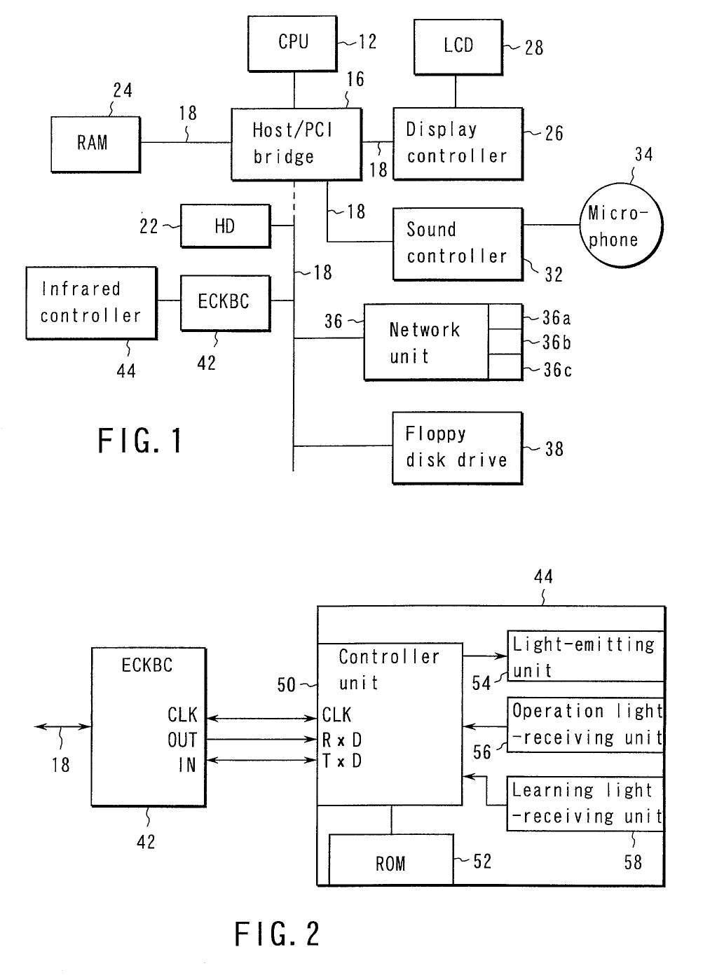

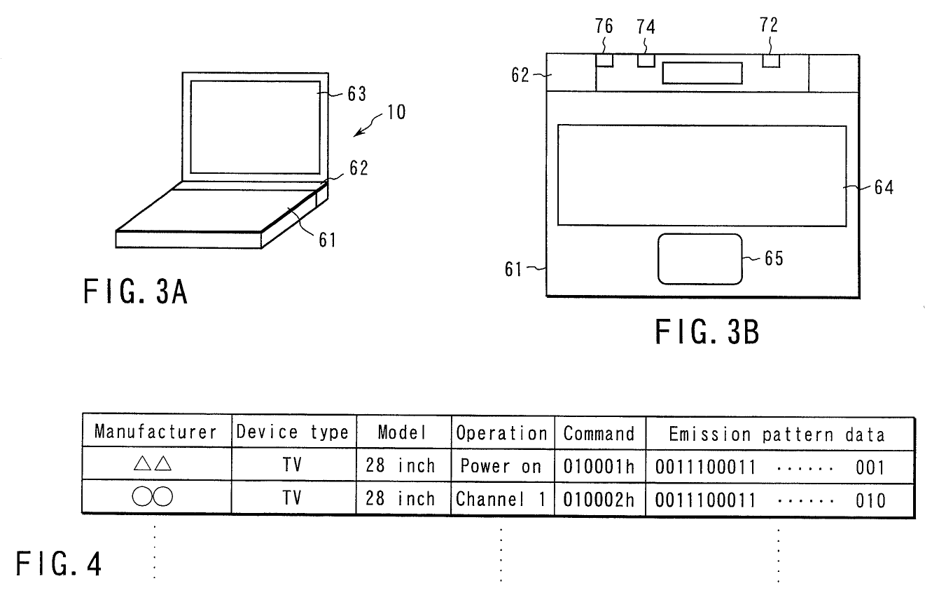

FIGS. 3A and 3B are respectively a perspective view showing a personal computer (PC) according to an embodiment of the present invention, and a plan view showing its base unit. FIG. 1 is a block diagram showing the circuit arrangement of the PC shown in FIGS. 3A and 3B, and FIG. 2 is a block diagram showing specific part of the circuit arrangement shown in FIG. 1.

As shown in FIG. 3A, a main body 10 of this PC includes a base unit 61, and a display unit 63 which is pivotally attached to the base unit 61 via a hinge portion 62. The base unit 61 includes a computer circuit, i.e., a CPU (Central Processing Unit) 12. A keyboard 64, control pad 65, and the like are disposed on the base unit 61 in a known pattern. On the other hand, the display unit 66 includes an LCD (Liquid Crystal Display) 28, so that its display surface faces the base unit 61.

As shown in FIG. 1, a host/PCI bridge 16 is connected to the CPU 12 via a processor bus 14. Storage devices such as an HD (Hard Disk) 22, RAM (Random Access Memory) 24, and the like, and a display controller 26 for the LCD 28 are connected to the CPU 12 via the bridge 16 and individual PCI buses 18. Also, a sound controller 32, network unit 36, and floppy disk drive 38 are connected to the CPU 12 via the bridge 16 and individual PCI buses 18.

More specifically, the PC main body 10 incorporates a speech or audio input unit including the sound controller 32 and a microphone 34. The sound controller 32 can make various input operations to the CPU 12 on the basis of an audio signal input via the microphone 34. The network unit 36 includes a communication modem unit 36a, LAN (Local Area Network) card unit 36b, interface unit 36c with external devices, and the like. The network unit 36 can input externally input data and signals to the CPU 12 via these units 36a to 36c.

An ECKBC (Embedded Controller·Keyboard Controller: a keyboard controller embedded with various functions) 42 is connected to the CPU 12 via the bridge 16 and a PCI bus 18, and an infrared controller 44 is connected to the ECKBC 42. Therefore, the CPU 12 can access the infrared controller 44 via the bridge 16 and ECKBC 42. The infrared controller 44 transmits/receives via infrared communications, and serves as a transmitter (remote controller) for remote-controlling external electronic devices using infrared signals, and also as a receiver for remote-controlling the PC internal circuit using infrared signals from external remote controllers.

As shown in FIG. 2, the infrared remote controller includes a controller unit 50 which is connected to the ECKBC 42 by, e.g., a two-way clock sync system, and can make serial communications with external devices. To the controller unit 50, a programmable ROM (Read-Only Memory) 52, a light-emitting unit (transmitter) 54 for externally emitting infrared rays, and an operation light-receiving unit (receiver) 56 and learning light-receiving unit (receiver) 58 for receiving external infrared rays are connected. The light-emitting unit 54, and light-receiving units 56 and 58 respectively comprise, e.g., a semiconductor light-emitting element and semiconductor light-receiving elements for infrared rays.

The light-emitting unit 54, and light-receiving units 56 and 58 face windows 72, 74, and 76 formed on the hinge portion 62, as shown in FIG. 3B. The windows 72, 74, and 76 form part of the corner of the hinge portion 62 on the rear side, and are externally exposed either when the display unit 66 is opened or closed with respect to the base unit 61. As will be described later, the light-emitting unit 54, and light-receiving units 56 and 58 can be disposed at positions away from the PC main body 10.

The light-emitting unit 54 is used to output a remote-control infrared signal for external electronic devices. For this purpose, the controller unit 50 includes an emission processor for modulating infrared rays to be emitted by the light-emitting unit 54 so as to form an emission pattern of the infrared ray signal. The emission processor executes an emission process on the basis of data of infrared signals registered in the ROM 52 or HD 22.

The operation light-receiving unit 56 is used to receive a remote-control infrared signal for the internal computer circuit, i.e., the CPU 12, from an external remote controller. For this purpose, the controller unit 50 includes an operation light-receiving processor for inputting commands to the CPU 12 on the basis of the infrared signal received by the operation light-receiving unit 56. Such commands input in this way include a command for controlling an infrared signal to be emitted by the light-emitting unit 54. Note that the operation light-receiving processor samples the infrared signal input from the operation light-receiving unit 56 at a frequency of, e.g., about 38 kHz, so as to execute processes.

The learning light-receiving unit 58 is used to learn an emission pattern of the remote-control infrared signal for an external electronic device, which is not registered in the ROM 52 or HD 22. To this end, the controller unit 50 includes a learning light-receiving processor for forming emission pattern data on the basis of an infrared signal received by the learning light-receiving unit 58, and inputting it to the CPU 12. The learned data is temporarily registered in the HD 22 by the CPU 12, and is used to update data on the ROM 52 as needed. Note that the learning light-receiving processor samples the infrared signal input from the learning light-receiving unit 58 at a frequency of, e.g., about 400 to 500 kHz, so as to execute processes.

FIG. 4 shows an example of the data structure of an infrared signal.

Emission pattern data differ for respective device types and models to avoid interference of infrared remote controllers, and also have different pattern lengths. In general, a remote controller and a device to be controlled have one-to-one compatibility, but remote controllers for some devices such as a VTR, TV, and the like can be compatible to several device types. However, since device types and models increase year by year, devices to which such remote controllers are not compatible increase. From such viewpoint, in the present invention, a data structure that can update emission pattern data is built.

In the PC shown in FIGS. 1 to 3B, latest data are registered in the HD 22 of the PC main body 10 and the ROM 52 in the infrared controller 44 in an initial state. When a remote-control infrared signal is output to an external electronic device, the CPU 12 sends only a command to the infrared controller 44. This command is converted into pattern data by the controller unit 50 in the infrared controller 44.

When a new compatible device type is added (when an unregistered external electronic device is newly registered), the CPU 12 updates or changes data on the HD 22, and also updates or changes data on the ROM 52 as needed. Data of a new device type can be obtained by reading an infrared signal emitted by a remote controller for the new device type via the learning light-receiving unit 58. Also, data of a new device type can be input from an external network connected to the network unit 36 or can be read from a storage medium loaded into the floppy disk drive 38 or the like.

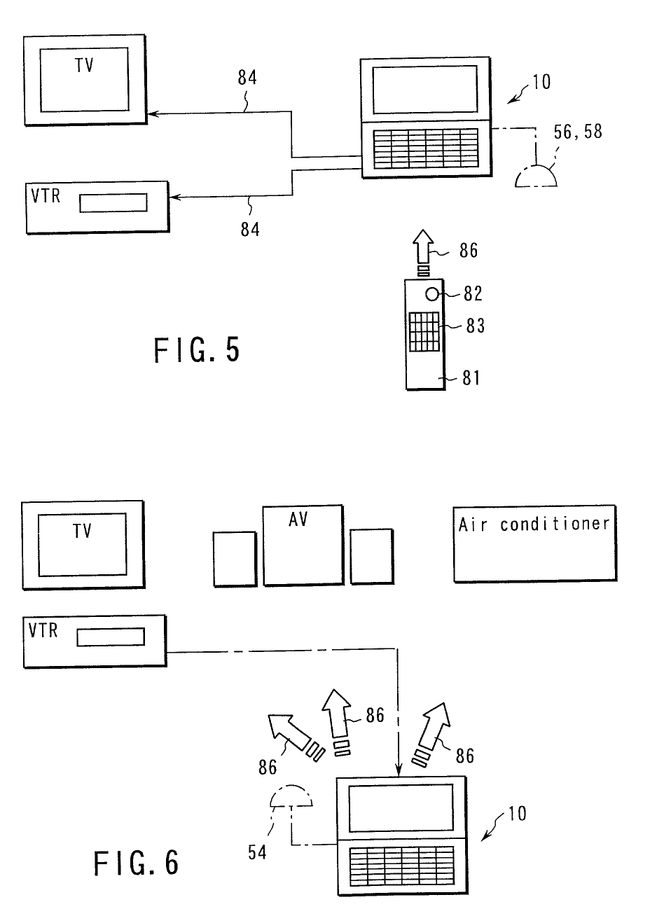

FIG. 5 shows the relationship between a PC and external electronic devices according to another embodiment of the present invention, to which the concept of the embodiment shown in FIGS. 1 to 4 is applied.

In this embodiment, the PC main body 10 can be remote-controlled by an infrared signal 86 coming from an external remote controller 81 via the aforementioned operation light-receiving unit 56, and the operation light-receiving processor (see FIG. 2) of the controller unit 50. On the remote controller 81, a button 82 for turning on/off the power supply of the PC main body 10, keys 83 for inputting commands, and the like are arranged. On the other hand, the PC main body 10 and external electronic devices such as a TV, VTR, and the like are connected via cables 84.

According to this embodiment, the external remote controller 81 allows to turn on/off the power supply of the PC main body 10 and to operate its internal circuit can be operated from a remote place. Hence, the internal functions of the PC main body 10, e.g., DVD (Digital Versatile Disc) playback, CD (Compact Disc) playback, and the like, can be remote-controlled, and functions of external electronic devices connected via lines, e.g., selection of TV channels upon displaying an image on the TV, playback and video recording of the VTR, and the like can be remote-controlled. The PC main body 10 can be used as a timer for the external electronic devices when it is programmed.

Note that the light-receiving units 56 and 58 can be disposed at positions away from the PC main body 10, as indicated by the one-dashed chain line in FIG. 5. The PC main body 10 and external electronic devices can be connected by infrared communications via the aforementioned light-emitting unit 54 and the emission processor (see FIG. 2) of the controller unit 50.

FIG. 6 shows the relationship between a PC and external electronic devices according to still another embodiment of the present invention, to which the concept of the embodiment shown in FIGS. 1 to 4 is applied.

In this embodiment, the PC main body 10 and external electronic devices such as a TV, VTR, AV (Audio Video), air conditioner, and the like are connected by infrared communications via the aforementioned light-emitting unit 54 and the emission processor (see FIG. 2) of the controller unit 50.

According to this embodiment, when a predetermined command is input from the keyboard 64 or the like of the PC main body 10 to the CPU 12, the CPU 12 supplies a corresponding emission command to the controller unit 50 of the infrared controller 44 via the ECKBC 42. The controller unit 50 modulates infrared rays to be emitted by the light-emitting unit 54 to form an emission pattern of an infrared signal 86 on the basis of the received emission command. In this way, the external electronic device is remote-controlled by a command input via the keyboard 64 or the like.

Note that the light-emitting unit 54 may be disposed at a position away from the PC main body 10, as indicated by the one-dashed chain line in FIG. 6. Also, when the PC main body 10 and the external electronic device such as a TV, VTR, and the like are connected via a cable 85, as indicated by the one-dashed chain line in FIG. 6, information, e.g., an image or the like, can be sent from such device to the PC main body 10. Furthermore, the internal circuit of the PC main body 10 may be remote-controlled using the external remote controller 81, as in the embodiment shown in FIG. 5.

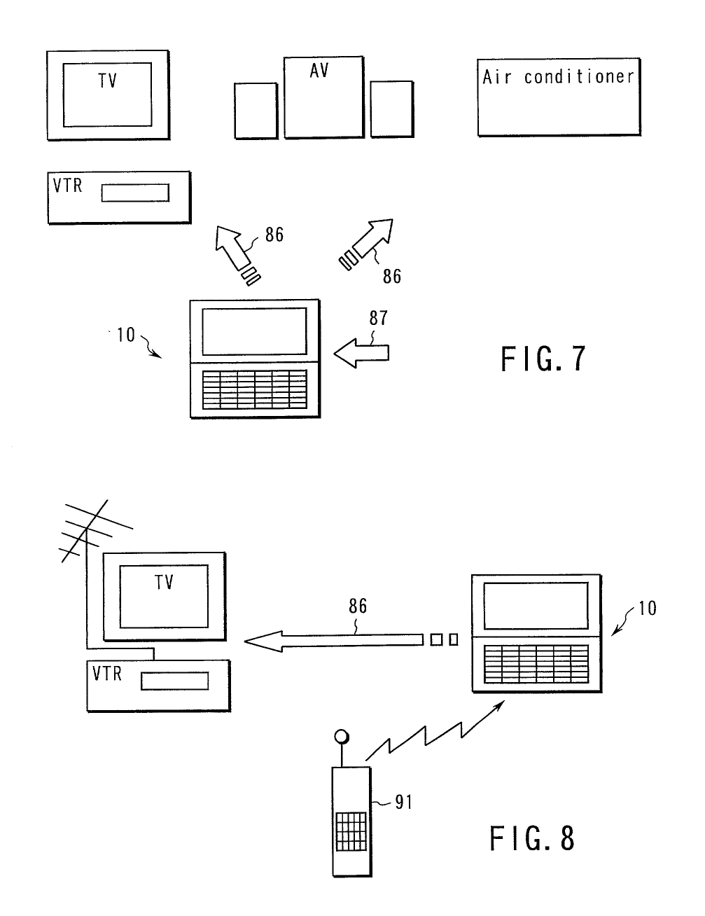

FIG. 7 shows the relationship between a PC and external electronic devices according to still another embodiment of the present invention, to which the concept of the embodiment shown in FIGS. 1 to 4 is applied.

In this embodiment, the PC main body 10 incorporates a speech or audio input unit (see FIG. 1) including the sound controller 32 and microphone 34, i.e., a speech or audio recognition function. Therefore, the internal circuit of the PC main body 10 can be controlled by a speech or audio command 87 input via the microphone 34. On the other hand, the PC main body 10 and external electronic devices such as a TV, VTR, AV, air conditioner, and the like are connected by infrared communications via the aforementioned light-emitting unit 54 and the emission processor (see FIG. 2) of the controller unit 50.

According to this embodiment, correspondence between speech or audio and emission commands is registered in advance in, e.g., the HD 22. When a speech command 87 is input via the microphone 34, the sound controller 32 makes speech recognition, and inputs a command to the CPU 12 on the basis of the recognition result. When the input speech command is pre-registered in correspondence with a given emission command, the CPU 12 sends the corresponding emission command to the controller unit 50 of the infrared controller 44. The controller unit 50 controls the light-emitting unit 54 to emit a predetermined infrared signal 86 on the basis of the received emission command. As a result, the external electronic device is remote-controlled by the speech command input via the speech input unit.

FIG. 8 shows the relationship between a PC and external electronic devices according to still another embodiment of the present invention, to which the concept of the embodiment shown in FIGS. 1 to 4 is applied.

In this embodiment, the PC main body 10 incorporates the network unit 36 (see FIG. 1) which includes the communication modem unit 36a for a telephone line. Therefore, the internal circuit of the PC main body 10 can be controlled by a communication command (communication code) input via the modem unit 36a. Also, the PC main body 10 has a modem wake-up function, and its power supply can be turned on/off in response to a signal input via the modem unit 36a. On the other hand, the PC main body 10 and external electronic devices such as a TV, VTR, and the like are connected by infrared communications via the aforementioned light-emitting unit 54 and the emission processor (see FIG. 2) of the controller unit 50.

According to this embodiment, correspondence between communication and emission commands are registered in advance in, e.g., the HD 22. When a communication code is input from a portable phone or normal telephone (a portable phone 91 is illustrated in FIG. 8) to the CPU 12 via the modem 36a, the CPU 12 converts the communication code into a command or the like. Note that a speech or audio command may be input from a telephone using the speech or audio recognition function as in the embodiment shown in FIG. 7.

When the input command is pre-registered in correspondence with a given emission command, the CPU 12 sends the corresponding emission command to the controller unit 50 of the infrared controller 44. The controller unit 50 controls the light-emitting unit 54 to emit a predetermined infrared signal 86 on the basis of the received emission command. As a result, the external electronic device is remote-controlled by the communication command input via the modem 36a.

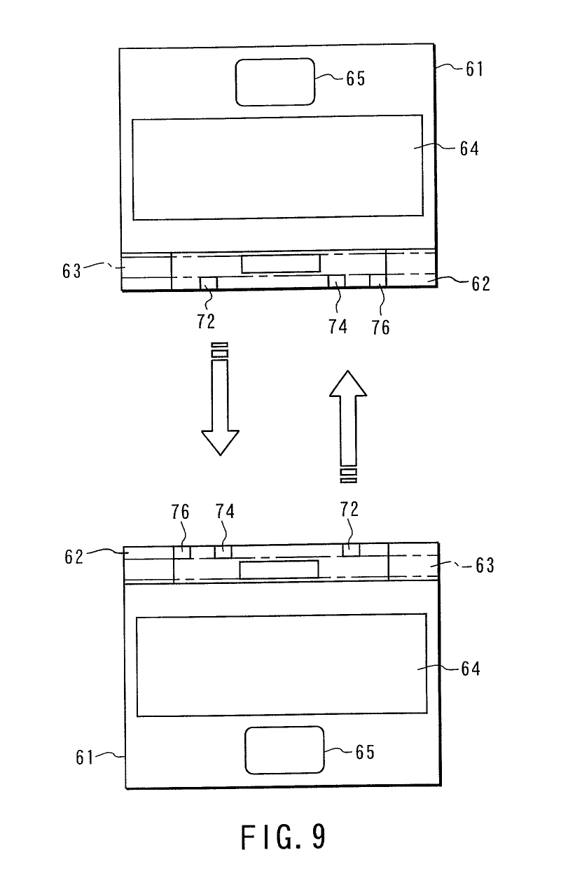

FIG. 9 is a diagram showing the relationship between two individuals of a PC according to still another embodiment of the present invention, to which the concept of the embodiment shown in FIGS. 1 to 4 is applied.

In this embodiment, the emission processor and the light-receiving processor of the controller unit 50 in the PC main body, and the light-emitting unit 54 (corresponding to the window 72) and the light-receiving unit 56 (corresponding to the window 74) are arranged to allow two PC individuals P1 and P2 to be connected to each other by infrared communications. Accordingly, the light-emitting units 54 and the emission processors of the PC individuals P1 and P2 are able not only to output a remote-control infrared signal for external electronic devices, but also to output information (data) to the light-receiving units 56 of the other PC individuals P2 and P1. The light-receiving units 56 and the light-receiving processors of the PC individuals P1 and P2 are able not only to receive a remote-control infrared signal from an external remote controller, but also to receive information (data) output from the light-emitting units 54 of the other PC individuals P2 and P1.

In the aforementioned embodiments, infrared rays are used as communication media for remote control. Alternatively, other light rays or other electro-magnetic waves may be used as such communication media within the usable range. Also, in the aforementioned embodiments, serial communications are used as communications for remote control, but parallel communications may be used.

According to the present invention, since a plurality of electronic devices can be remote-controlled by a single PC, the remote controllability of the electronic devices can be improved, and remote controllers can be prevented from being wasted. Also, according to the present invention, since the PC can be remote-controlled by a remote controller, the operability of the PC itself can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A personal computer comprising:
a main body which incorporates a computer circuit;
a light-emitting unit which externally emits light rays; and
an emission processor which is connected to the computer circuit and the light-emitting unit, and modulates the light rays emitted by the light-emitting unit to form an emission pattern of an optical signal for remote-controlling an external electronic device.

2. The personal computer according to claim 1, further comprising:
a first light-receiving unit which receives external light rays; and
a first light-receiving processor which is connected to the computer circuit and the first light-receiving unit, and inputs a command to the computer circuit on the basis of an optical signal for remote-controlling the computer circuit, which is received by the first light-receiving unit.

3. The personal computer according to claim 1, further comprising:
a second light-receiving unit which receives external light rays; and
a second light-receiving processor which is connected to the computer circuit and the second light-receiving unit, and learns an emission pattern of an optical signal for remote-controlling the external electronic device, which is received by the second light-receiving unit.

4. The personal computer according to claim 1, further comprising a programmable ROM used to register data of an optical signal for remote-controlling the external electronic device.

5. The personal computer according to claim 1, wherein the main body comprises a storage device connected to the computer circuit, and the data of the optical signal for remote-controlling the external electronic device is saved in the storage device, and is sent from the computer circuit to the emission processor.

6. The personal computer according to claim 5, wherein the main body comprises a network unit connected to the computer circuit, the data of the optical signal for remote-controlling the external electronic device, which is saved in the storage device, are updated or changed by data from an external network connected to the network unit or a storage medium which is connected to the computer circuit upon being selectively loaded into the main body.

7. The personal computer according to claim 1, wherein the main body comprises an audio input unit connected to the computer circuit, and the emission processor is controlled on the basis of an audio command input to the audio input unit with reference to pre-registered correspondence between audio commands and emission command.

8. The personal computer according to claim 1, wherein the main body comprises a network unit connected to the computer circuit, and the emission processor is controlled on the basis of a command input from an external network connected to the network unit.

9. The personal computer according to claim 1, wherein the main body comprises a modem unit connected to the computer circuit, and the emission processor is controlled on the basis of a command input from a telephone via the modem unit.

10. A personal computer comprising:
a base unit which incorporates a computer circuit and includes a keyboard;
a display unit which is pivotally attached to the base unit via a hinge portion;
a light-emitting unit which is disposed on the base unit and externally emits light rays; and
an emission processor which is connected to the computer circuit and the light-emitting unit, and modulates the light rays emitted by the light-emitting unit to form an emission pattern of an optical signal for remote-controlling an external electronic device.

11. The personal computer according to claim 10, further comprising:
a first light-receiving unit which is disposed on the base unit and receives external light rays; and
a first light-receiving processor which is connected to the computer circuit and the first light-receiving unit, and inputs a command to the computer circuit on the basis of an optical signal for remote-controlling the computer circuit, which is received by the first light-receiving unit.

12. The personal computer according to claim 10, further comprising:
a second light-receiving unit which is disposed on the base unit and receives external light rays; and
a second light-receiving processor which is connected to the computer circuit and the second light-receiving unit, and learns an emission pattern of an optical signal for remote-controlling the external electronic device, which is received by the second light-receiving unit.

13. A personal computer comprising:
a main body which incorporates a computer circuit;
a light-emitting unit which externally emits light rays;
an emission processor which is connected to the computer circuit and the light-emitting unit, and modulates the light rays emitted by the light-emitting unit to form an emission pattern of an optical signal for remote-controlling an external electronic device;
a first light-receiving unit which receives external light rays; and
a first light-receiving processor which is connected to the computer circuit and the first light-receiving unit, and inputs a command to the computer circuit on the basis of an optical signal for remote-controlling the computer circuit, which is received by the first light-receiving unit,
wherein the light-emitting unit, the emission processor, the first light-receiving unit, and the first light-receiving processor are arranged to allow two individuals of the personal computer to be connected to each other by optical communications.

14. The personal computer according to claim 13, further comprising:
a second light-receiving unit which receives external light rays; and
a second light-receiving processor which is connected to the computer circuit and the second light-receiving unit, and learns an emission pattern of an optical signal for remote-controlling the external electronic device, which is received by the second light-receiving unit.

15. The personal computer according to claim 13, wherein the main body comprises a base unit which incorporates a computer circuit and includes a keyboard, and a display unit which is pivotally attached to the base unit via a hinge portion.
